(19) United States
(12) Patent Application Publication
(10) Pub. No.: US 2014/0222335 A1
(43) Pub. Date: Aug. 7, 2014

(54) Concurrent Multi-Point Contact Gesture Detection and Response

(71) Applicant: Apple, Inc., Cupertino, CA (US)

(72) Inventors: Patrick S. Piemonte, Cupertino, CA (US); Marcel Van Os, Cupertino, CA (US); Christopher Blumenberg, Cupertino, CA (US)

(21) Appl. No.: 13/757,907

(22) Filed: Feb. 4, 2013

(51) Int. Cl. G01C 21/36

(52) U.S. Cl. CPC G01C 21/3614
USPC 701/527; 701/538; 701/533

(57) ABSTRACT

A mobile device including a touchscreen display can detect multiple points of fingertip contact being made against the touchscreen concurrently. The device can distinguish this multi-touch gesture from other gestures based on the duration, immobility, and concurrency of the contacts. In response to detecting such a multi-touch gesture, the device can send a multi-touch event to an application executing on the device. The application can respond to the multi-touch event in a variety of ways. For example, the application can determine a distance of a path in between points on a map that a user has concurrently touched with his fingertips. The application can display this distance to the user.

### BACKGROUND

The present disclosure relates generally to mobile devices, and in particular to techniques for manipulating mobile device user interfaces based on user interactions with those mobile devices.

A mobile device (also known as a handheld device, handheld computer, or simply handheld) can be a small, hand-held computing device, typically having a display screen with touch input and/or a miniature keyboard. A handheld computing device has an operating system (OS), and can run various types of application software, sometimes called “apps.” Most handheld devices can also be equipped with Wi-Fi, Bluetooth, and global positioning system (GPS) capabilities. Wi-Fi components can allow wireless connections to the Internet. Bluetooth components can allow wireless connections to other Bluetooth capable devices such as an automobile or a microphone headset. A camera or media player feature for video or music files can also be typically found on these devices along with a stable battery power source such as a lithium battery. Mobile devices often come equipped with a touchscreen interface that acts as both an input and an output device.

Mobile phones are a kind of mobile device. A mobile phone (also known as a cellular phone, cell phone, or hand phone) is a device that can make and receive telephone calls over a radio link while moving around a wide geographic area. A mobile phone can do so by connecting to a cellular network provided by a mobile phone operator, allowing access to the public telephone network. In addition to telephony, modern mobile phones can often also support a wide variety of other services such as text messaging, multimedia messaging service (MMS), e-mail, Internet access, short-range wireless communications (infrared, Bluetooth, etc.), business applications, gaming, and photography. Mobile phones that offer these and more general computing capabilities are often referred to as smart phones.

The Apple iPhone, in its various generations, is a smart phone. The iPhone includes a variety of components, such as a GPS, an accelerometer, a compass, and a gyroscope, which the iPhone's OS can use to determine the iPhone's current location, orientation, speed, and attitude. The iPhone's OS can detect events from these components and pass these events on to applications that are executing on the iPhone. Those applications can then handle the events in a manner that is custom to those applications. For example, using its built-in components, the iPhone can detect when it is being shaken, and can pass an event representing the shaking on to applications that have registered to listen for such an event. An application can respond to that event, for example, by changing the images that the iPhone is currently presenting on its touchscreen display.

Like many mobile devices, the iPhone, and its cousins the iPad and iPod Touch, come equipped with a touchscreen interface that can detect physical contact from a user of the mobile device and generate a corresponding event. For example, the iPhone can detect when a user has single-tapped the screen, double-tapped the screen, made a pinching motion relative to the screen, made a swiping motion across the screen, or made a flicking motion on the screen with his fingertips. Each such user interaction relative to the iPhone can cause a different kind of corresponding event to be generated for consumption by interested applications. Thus, the iPhone, iPad, and iPod Touch are able to detect and respond to a variety of physical interactions that a user can take relative those devices.

A mobile device's touchscreen is usually the primary mechanism by which the mobile device's user interacts with user interface elements (e.g., icons) that are displayed on the touchscreen. Thus, if a user desires to launch an application, the user might tap on the application's icon shown on the mobile device's display. Alternatively, if a user desires to move an icon from one location to another in the user interface, the user might press down on that icon's location on the display and then slide his fingertip across the touchscreen to the destination at which the user wants the icon to be placed. A user of a more conventional computer, such as a desktop computer, would likely use a separate pointing device such as a mouse to perform similar operations.

One popular application that mobile devices often provide to their users is a map application. A map application can show the user a map of a geographical region of the user's choice, usually including roads and points of interest within that region. If the user is aware of an address to which he would like to navigate with the region, the user can specify that address to the map application, and the map application can show the user the point on the map at where that address is located. The map application can even plot a route from the user's current location to the point at which the specified address is located. Sometimes, however, a user might not know the address of the location in which he is interested; the user might only have a rough idea of where, on the map, he wants to go.

### BRIEF DESCRIPTION

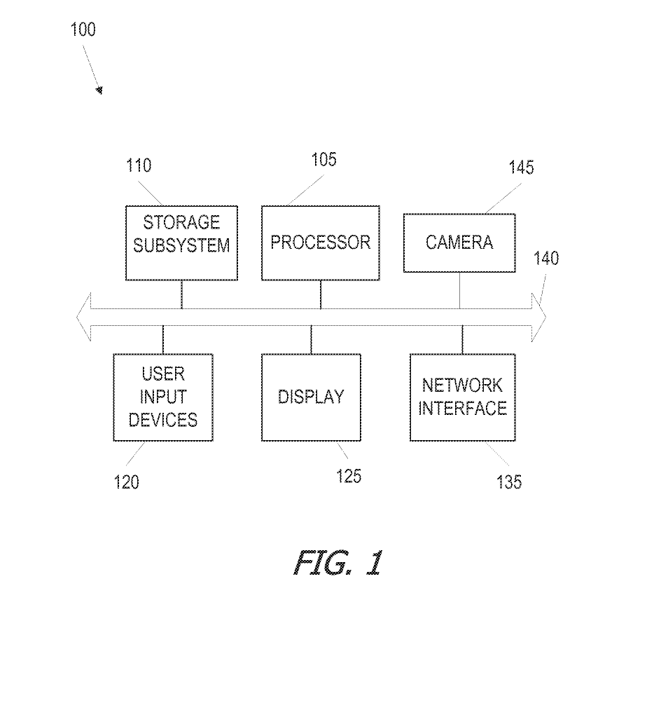

FIG. 1 is a block diagram of a computer system according to an embodiment of the present invention.

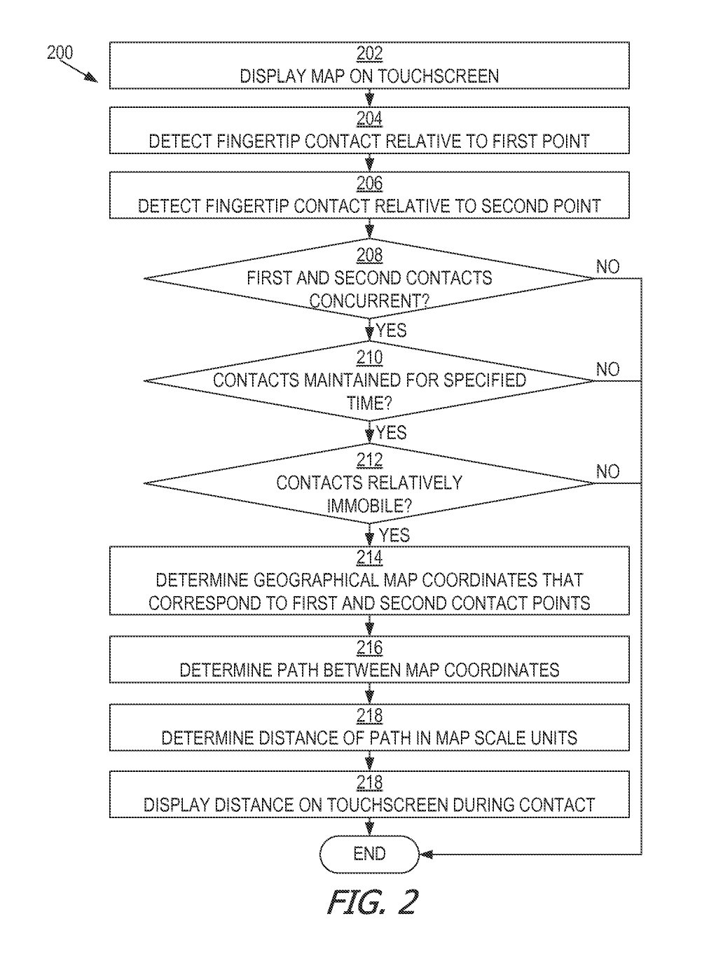

FIG. 2 is a flow diagram illustrating an example of a technique for presenting a distance of a path in between two points on a map in response to detecting a multi-touch gesture relative to touchscreen points to which the map points correspond, according to an embodiment of the invention.

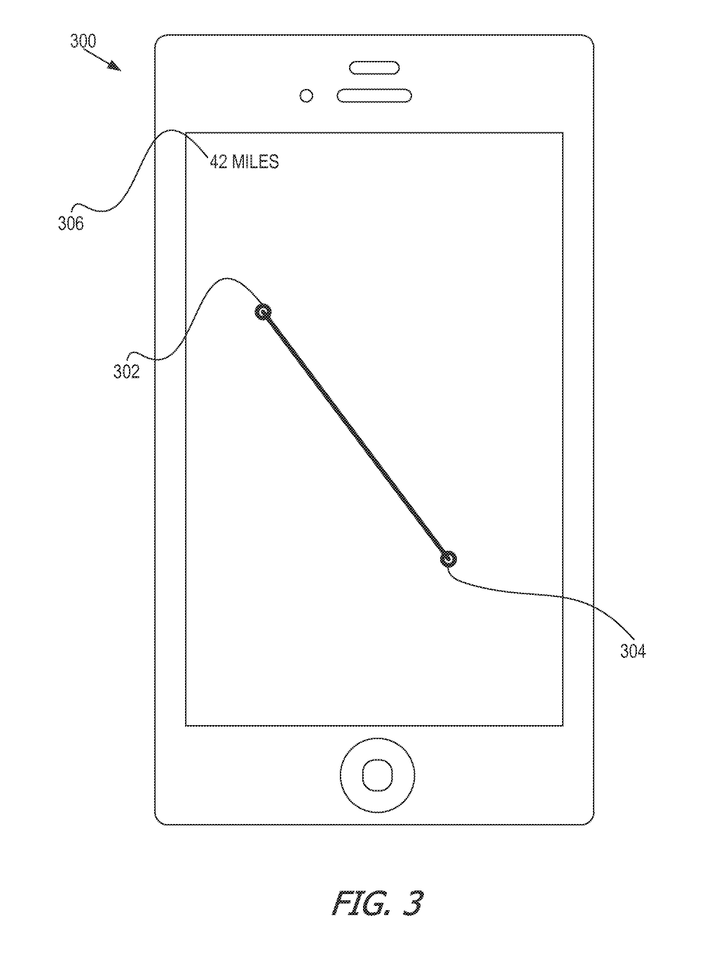

FIG. 3 is a block diagram illustrating an example of a mobile device that is capable of presenting information about a linear path in between two points of contact in response to the establishment and maintenance of a multi-contact gesture against the device's touchscreen display, according to an embodiment of the invention.

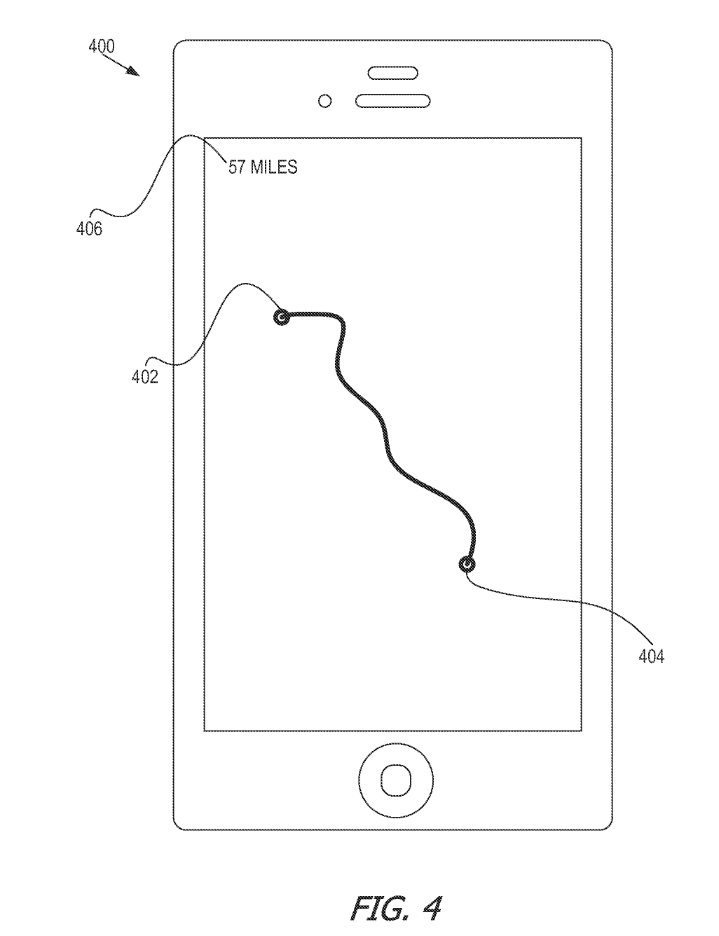

FIG. 4 is a block diagram illustrating an example of a mobile device that is capable of presenting information about a non-linear path along fixed channels in between two points of contact in response to the establishment and maintenance of a multi-contact gesture against the device's touchscreen display, according to an embodiment of the invention.

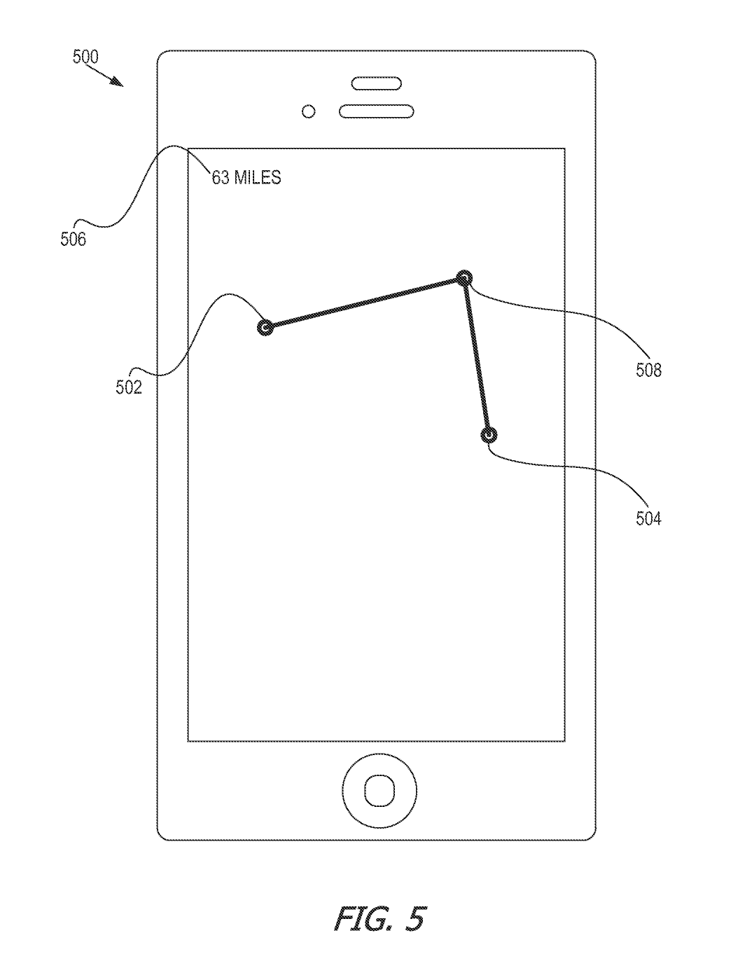

FIG. 5 is a block diagram illustrating an example of a mobile device that is capable of presenting information about a path through three or more points of contact in response to the establishment and maintenance of a multi-contact gesture against the device's touchscreen display, according to an embodiment of the invention.

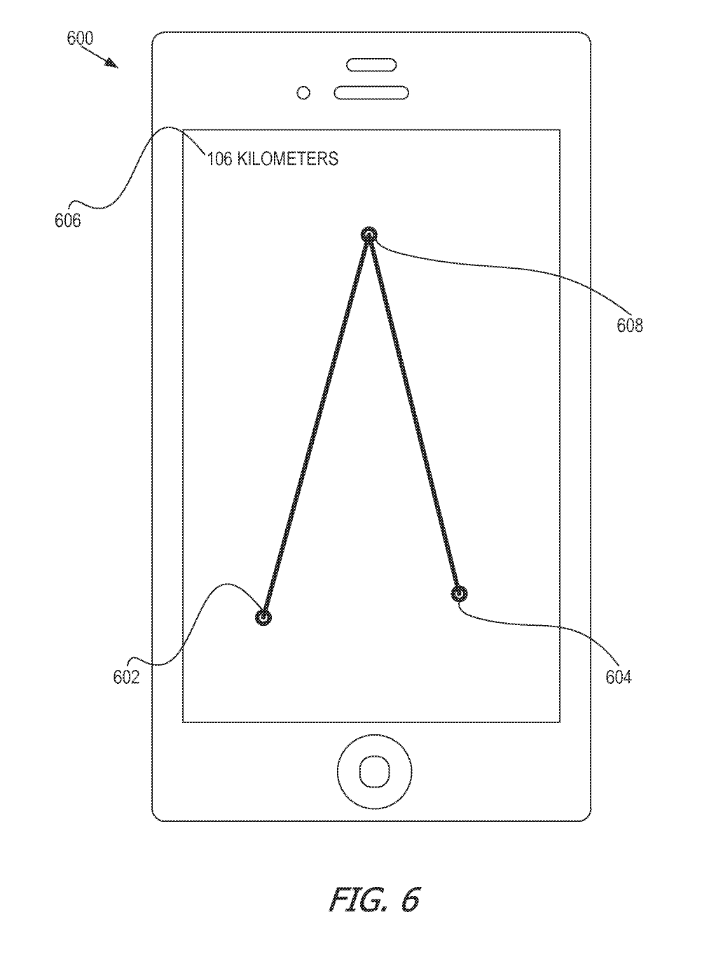

FIG. 6 is a block diagram illustrating an example of a mobile device that is capable of determining an order in which three or more points of contact were established against the device's touchscreen display as part of a multi-contact gesture, and of calculating a path through each of those points based at least in part on that order, according to an embodiment of the invention.

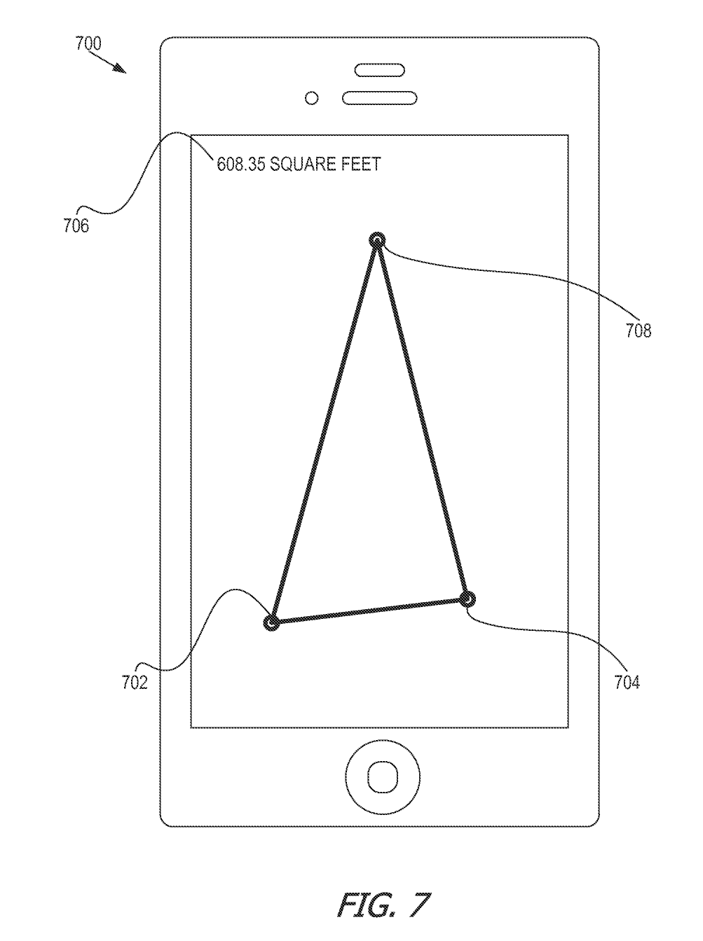

FIG. 7 is a block diagram illustrating an example of a mobile device that is capable of drawing a shape having vertices that include three or more points of contact in response to the establishment and maintenance of a multi-contact gesture against the device's touchscreen display, according to an embodiment of the invention.

### DETAILED DESCRIPTION

Embodiments of the invention can involve a mobile device that includes a touchscreen display. The mobile device can detect multiple points of fingertip contact being made against the touchscreen concurrently. The device can distinguish this multi-touch gesture from other gestures based on the duration, immobility, and concurrency of the contacts. In response to detecting such a multi-touch gesture, the device can send a multi-touch event to an application executing on the device. The application can respond to the multi-touch event in a variety of ways. For example, the application can determine a distance of a path in between points on a map that a user has concurrently touched with his fingertips. The application can display this distance to the user.

The following detailed description together with the accompanying drawings will provide a better understanding of the nature and advantages of the present invention.

FIG. 1 illustrates a computing system 100 according to an embodiment of the present invention. Computing system 100 can be implemented as any of various computing devices, including, e.g., a desktop or laptop computer, tablet computer, smart phone, personal data assistant (PDA), or any other type of computing device, not limited to any particular form factor. Computing system 100 can include processing unit(s) 105, storage subsystem 110, input devices 120, display 125, network interface 135, and bus 140. Computing system 100 can be an iPhone or an iPad.

Processing unit(s) 105 can include a single processor, which can have one or more cores, or multiple processors. In some embodiments, processing unit(s) 105 can include a general-purpose primary processor as well as one or more special-purpose co-processors such as graphics processors, digital signal processors, or the like. In some embodiments, some or all processing units 105 can be implemented using customized circuits, such as application specific integrated circuits (ASICs) or field programmable gate arrays (FPGAs). In some embodiments, such integrated circuits execute instructions that are stored on the circuit itself. In other embodiments, processing unit(s) 105 can execute instructions stored in storage subsystem 110.

Storage subsystem 110 can include various memory units such as a system memory, a read-only memory (ROM), and a permanent storage device. The ROM can store static data and instructions that are needed by processing unit(s) 105 and other modules of computing system 100. The permanent storage device can be a read-and-write memory device. This permanent storage device can be a non-volatile memory unit that stores instructions and data even when computing system 100 is powered down. Some embodiments of the invention can use a mass-storage device (such as a magnetic or optical disk or flash memory) as a permanent storage device. Other embodiments can use a removable storage device (e.g., a floppy disk, a flash drive) as a permanent storage device. The system memory can be a read-and-write memory device or a volatile read-and-write memory, such as dynamic random access memory. The system memory can store some or all of the instructions and data that the processor needs at runtime.

Storage subsystem 110 can include any combination of computer readable storage media including semiconductor memory chips of various types (DRAM, SRAM, SDRAM, flash memory, programmable read-only memory) and so on. Magnetic and/or optical disks can also be used. In some embodiments, storage subsystem 110 can include removable storage media that can be readable and/or writeable; examples of such media include compact disc (CD), read-only digital versatile disc (e.g., DVD-ROM, dual-layer DVD-ROM), read-only and recordable Blu-Ray® disks, ultra density optical disks, flash memory cards (e.g., SD cards, mini-SD cards, micro-SD cards, etc.), magnetic “floppy” disks, and so on. The computer readable storage media do not include carrier waves and transitory electronic signals passing wirelessly or over wired connections.

In some embodiments, storage subsystem 110 can store one or more software programs to be executed by processing unit(s) 105. “Software” refers generally to sequences of instructions that, when executed by processing unit(s) 105 cause computing system 100 to perform various operations, thus defining one or more specific machine implementations that execute and perform the operations of the software programs. The instructions can be stored as firmware residing in read-only memory and/or applications stored in magnetic storage that can be read into memory for processing by a processor. Software can be implemented as a single program or a collection of separate programs or program modules that interact as desired. Programs and/or data can be stored in non-volatile storage and copied in whole or in part to volatile working memory during program execution. From storage subsystem 110, processing unit(s) 105 can retrieves program instructions to execute and data to process in order to execute various operations described herein.

A user interface can be provided by one or more user input devices 120, display device 125, and/or and one or more other user output devices (not shown). Input devices 120 can include any device via which a user can provide signals to computing system 100; computing system 100 can interpret the signals as indicative of particular user requests or information. In various embodiments, input devices 120 can include any or all of a keyboard, touch pad, touch screen, mouse or other pointing device, scroll wheel, click wheel, dial, button, switch, keypad, microphone, and so on.

Display 125 can display images generated by computing system 100 and can include various image generation technologies, e.g., a cathode ray tube (CRT), liquid crystal display (LCD), light-emitting diode (LED) including organic light-emitting diodes (OLED), projection system, or the like, together with supporting electronics (e.g., digital-to-analog or analog-to-digital converters, signal processors, or the like). Some embodiments can include a device such as a touchscreen that function as both input and output device. In some embodiments, other user output devices can be provided in addition to or instead of display 125. Examples include indicator lights, speakers, tactile “display” devices, printers, and so on.

In some embodiments, the user interface can provide a graphical user interface, in which visible image elements in certain areas of display 125 are defined as active elements or control elements that the user can select using user input devices 120. For example, the user can manipulate a user input device to position an on-screen cursor or pointer over the control element, then click a button to indicate the selection. Alternatively, the user can touch the control element (e.g., with a finger or stylus) on a touchscreen device. In some embodiments, the user can speak one or more words associated with the control element (the word can be, e.g., a label on the element or a function associated with the element). In some embodiments, user gestures on a touch-sensitive device can be recognized and interpreted as input commands; these gestures can be but need not be associated with any particular array in display 125. Other user interfaces can also be implemented.

Network interface 135 can provide voice and/or data communication capability for computing system 100. In some embodiments, network interface 135 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments, network interface 135 can provide wired network connectivity (e.g., Ethernet) in addition to or instead of a wireless interface. Network interface 135 can be implemented using a combination of hardware (e.g., antennas, modulators/demodulators, encoders/decoders, and other analog and/or digital signal processing circuits) and software components.

Bus 140 can include various system, peripheral, and chipset buses that communicatively connect the numerous internal devices of computing system 100. For example, bus 140 can communicatively couple processing unit(s) 105 with storage subsystem 110. Bus 140 also connects to input devices 120 and display 125. Bus 140 also couples computing system 100 to a network through network interface 135. In this manner, computing system 100 can be a part of a network of multiple computer systems (e.g., a local area network (LAN), a wide area network (WAN), an Intranet, or a network of networks, such as the Internet. Any or all components of computing system 100 can be used in conjunction with the invention.

A camera 145 also can be coupled to bus 140. Camera 145 can be mounted on a side of computing system 100 that is on the opposite side of the mobile device as display 125. Camera 145 can be mounted on the “back” of such computing system 100. Thus, camera 145 can face in the opposite direction from display 125.

Some embodiments include electronic components, such as microprocessors, storage and memory that store computer program instructions in a computer readable storage medium. Many of the features described in this specification can be implemented as processes that are specified as a set of program instructions encoded on a computer readable storage medium. When these program instructions are executed by one or more processing units, they cause the processing unit(s) to perform various operation indicated in the program instructions. Examples of program instructions or computer code include machine code, such as is produced by a compiler, and files including higher-level code that are executed by a computer, an electronic component, or a microprocessor using an interpreter.

Through suitable programming, processing unit(s) 105 can provide various functionalities for computing system 100. For example, processing unit(s) 105 can execute a multi-touch-sensitive map application. In some embodiments, the multi-touch-sensitive map application is a software-based process that can present, to a user, information (e.g., distance of) pertaining to a path that lies in between geographical points on a map that correspond to physical points on display 125 that the user is concurrently contacting with his fingertips.

It will be appreciated that computing system 100 is illustrative and that variations and modifications are possible. Computing system 100 can have other capabilities not specifically described here (e.g., mobile phone, global positioning system (GPS), power management, various connection ports for connecting external devices or accessories, etc.). Further, while computing system 100 is described with reference to particular blocks, it is to be understood that these blocks are defined for convenience of description and are not intended to imply a particular physical arrangement of component parts. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including electronic devices implemented using any combination of circuitry and software.

FIG. 2 is a flow diagram illustrating an example of a technique 200 for presenting a distance of a path in between two points on a map in response to detecting a multi-touch gesture relative to touchscreen points to which the map points correspond, according to an embodiment of the invention. For example, technique 200 can be performed by a mobile device or, more specifically, by an application program executing on that mobile device in conjunction with hardware components that detect fingertip contacts against a touchscreen display of the mobile device and send signals to that application program. Although certain operations are described as being performed in a certain order in technique 200, alternative embodiments of the invention can involve similar techniques being performed with fewer, additional, or different operations, and/or with those operations being performed in a different order.

In block 202, a mobile device can display a map of a geographical region on its touchscreen display. The map can include various roads and points of interest, such as cities occurring at points along those roads. In block 204, the mobile device can detect that a user has made a first fingertip contact relative to a first point on the touchscreen display. In block 206, the mobile device can detect that a user has made a second fingertip contact relative to a second point on the touchscreen display. In block 208, the mobile device can determine whether the first contact is being made concurrently with the second contact. If the first contact is being made concurrently with the second contact (i.e., multiple ones of the user's fingertips are touching the touchscreen at the same time), then control passes to block 210. Alternatively, if the first contact is not being made concurrently with the second contact, then technique 200 ends.

In block 210, the mobile device can determine whether the first contact and the second contact have both been maintained for at least a specified amount of time. For example, the mobile device can determine whether, during a specified interval of time following the making of the first and second contacts against the touchscreen display, either the first contact or the second contact has been broken. If the first contact and the second contact have been maintained against the touchscreen display for at least the specified amount of time, then control passes to block 212. Alternatively, if the first contact or the second contact has been broken during the specified interval of time, then technique 200 ends.

In block 212, the mobile device can determine whether the first contact and the second contact are relatively immobile. For example, the mobile device can determine whether, during a specified interval of time following the making of the first and second contacts, either the first contact or the second contact has been moved more than a specified threshold distance from the original points at which those contacts were made on the touchscreen display. If the first contact and the second contact are relatively immobile, then control passes to block 214. Alternatively, if the first contact or the second contact is not relatively immobile, then technique 200 ends.

In block 214, the mobile device can determine geographical coordinates on the map that correspond to the points at which the first and second contacts are being made against the touchscreen. For example, the mobile device can determine, for each of the first and second contacts, the geographical coordinates on the map that lie directly beneath the centers of the several parts of the touchscreen display against which contacts are being concurrently made. At this juncture in technique 200, the mobile device can have determined that the contacts being made concurrently against the mobile device's touchscreen display are indicative of a multi-point contact gesture rather than some other recognized gesture such as a pinch or a series of taps. The mobile device can have responsively generated a multi-touch gesture event that the map application can detect and to which the map application can react in a customized manner. In determining the geographical coordinates, the mobile device can perform a process called “reverse geocoding.” Reverse geocoding involves taking latitudinal and longitudinal coordinates as input and mapping those coordinates to a street address at (or closest to) those coordinates. Thus, in an embodiment, the mobile device can determine the latitudinal and longitudinal coordinates on the map that lie beneath each of the points of contact on the touchscreen, and can map those coordinates to street addresses.

In block 216, the mobile device can determine a path in between the geographical map coordinates. For example, the mobile device can determine a straight line in between the geographical map coordinates. For another example, the mobile device can select, from among routes along roads that are indicated on the map, a shortest route along roads from one of the geographical map coordinates (or a point on a road closest to that coordinate) to the other of the geographical map coordinates (or a point on a road closest to that coordinate). In one embodiment, the mobile device sends, to a remote route-determining server over a wireless network, the street addresses that the mobile device determined using the reverse geocoding process mentioned above. Such a remote server can then use the addresses as endpoints to plot the on-road route between those endpoints, and can send the route data back to the mobile device over the wireless network. In another embodiment, the mobile device can instead send, to the remote server, latitudinal and longitudinal coordinates corresponding each of the contact points, and the remote server can plot the on-road route based on those coordinates rather than street addresses. Although one embodiment of the invention can involve the determination of a route that can be traveled by automobile, in alternative embodiments of the invention, routes that can be traveled by pedestrians, bicyclists, public transit riders, etc., can be plotted, potentially depending on preferences indicated by the mobile device's user.

In block 218, the mobile device can determine a distance of the path that the mobile device determined in block 214. For example, the mobile device can retrieve information regarding the scale of the map in order to determine the distance of the path. Although the distance between the fingertip contacts might be measured in centimeters, the distance of the path might be measured in miles or some other fairly large units of length. In block 220, the mobile device can present, on the touchscreen display, information indicative of the distance of the path. For example, if the length of a route along roads between (1) the geographical coordinate beneath the first contact and (2) the geographical coordinates beneath the second contact is 42 miles, then the mobile device can indicate the distance of 42 miles at a conspicuous place on the touchscreen display. The mobile device can continue to present this distance information until at least one of the contacts against the display has been broken, at which time the device can cease to present that distance information to the device's user. Additionally or alternatively, the mobile device can continue to present this distance information until at least of the contacts against the display has been moved more than a relatively small threshold distance. Movement of a contact point can be indicative that the gesture that the user is making has changed—to a pinch, tilt, or pan gesture, for example. Techniques whereby a mobile device can distinguish between fingertip gestures made relative to a touchscreen are described in U.S. Provisional Patent Application No. 61/671,774, which is incorporated by reference herein.

In an embodiment discussed above, the mobile device can present distance information for the path in response to the multi-contact gesture being maintained against the touchscreen. The distance information can be in units of scale that are appropriate to the map on which the path is shown, such as miles, kilometers, feet, etc. However, in various alternative embodiments of the invention, the mobile device can additionally or alternatively present other kinds of information pertaining to such a path. For example, in one embodiment of the invention, the mobile device can present an estimated time that will be required to travel the path (e.g., in a car assumed to be travelling at the known speed limits along roads that the path follows). For another example, in one embodiment, the mobile device can present an estimate cost in money (e.g., accounting for the price of fuel and estimated vehicular mileage) to travel the path. For another example, in one embodiment, the mobile device can display or audibly utter textual or vocal turn-by-turn directions that the device's user should follow in order to navigate the path.

In an embodiment of the invention discussed above, the mobile device can calculate and present a path or route between two points on a map. The path that the mobile device determines can be the shortest available path, or the fastest available path, or the path involving the least cost (monetary or otherwise) to travel, or paths involving the satisfaction of various other user-specified constraints. However, in various alternative embodiments of the invention, the mobile device can alternatively calculate and determine paths or routes along fixed channels other than roads, and in contexts other than maps of geographical regions. For example, in one embodiment of the invention, the mobile device can present a graph that includes nodes and edges that link certain of those nodes together. In response to a user's establishment and maintenance of concurrent fingertip contact against two points corresponding to locations within the graph, the mobile device can automatically determine a shortest (or other specified criterion-satisfying) path along the edges from one location in the graph to the other location in the graph. Such a graph can represent various real-world systems. For example, such a graph can represent a packetized network diagram, in which the edges represent network connections having various specified bandwidths, and in which the nodes represent network routers, switches, hubs, etc.

For another example, in one embodiment, the mobile device can present a visual diagram of an organic system, such as a human anatomy, that contains nervous, circulatory, respiratory, and digestive channels between various organs. In response to a user's establishment and maintenance of concurrent fingertip contact against two points corresponding to locations within the graph, the mobile device can automatically determine a shortest (or other specified criterion-satisfying) path along the edges from one location in a contacted anatomical channel to the other location with the same or a different contacted anatomical channel. The mobile device can highlight this path within the diagram and/or present information pertaining to this path for as long as the multi-touch gesture is maintained. For another example, in one embodiment, the mobile device can present a maze. In response to a user's establishment and maintenance of concurrent fingertip contact against two points corresponding to locations within the maze, the mobile device can automatically determine a shortest (or other specified criterion-satisfying) path along the edges from one location in the maze to the other location in the maze. The mobile device can highlight this path within the maze and/or present information pertaining to this path for as long as the multi-touch gesture is maintained.

FIG. 3 is a block diagram illustrating an example of a mobile device 300 that is capable of presenting information about a linear path in between two points of contact in response to the establishment and maintenance of a multi-contact gesture against the device's touchscreen display, according to an embodiment of the invention. In one embodiment, mobile device 300 is a smart phone such as an Apple iPhone. In another embodiment, mobile device 300 is a tablet computer such as an Apple iPad. As shown in FIG. 3, a first point of contact 302 and a second point of contact 304 are being concurrently maintained against the touchscreen display of mobile device 300. In response to the concurrent maintenance of these points of contact, mobile device 300 can determine a straight linear path in between these points. Mobile device 300 can determine a distance 306 (e.g., in miles) between map locations to which these points and display distance 306 on the touchscreen display in response to the establishment of the multi-point contact gesture. Mobile device 300 can continue to display distance 306 on the touchscreen display until mobile device 300 determines that the multi-point contact gesture is no longer being maintained motionlessly against the touchscreen display, at which time mobile device 300 can cease to display distance 306.

FIG. 4 is a block diagram illustrating an example of a mobile device 400 that is capable of presenting information about a non-linear path along fixed channels in between two points of contact in response to the establishment and maintenance of a multi-contact gesture against the device's touchscreen display, according to an embodiment of the invention. In one embodiment, mobile device 400 is a smart phone such as an Apple iPhone. In another embodiment, mobile device 400 is a tablet computer such as an Apple iPad. As shown in FIG. 4, a first point of contact 402 and a second point of contact 404 are being concurrently maintained against the touchscreen display of mobile device 400. In response to the concurrent maintenance of these points of contact, mobile device 400 can determine a shortest (or other specified criteria-satisfying) path in between these points that follows fixed channels, such as roads, also shown on the touchscreen display. Mobile device 400 can determine a distance 406 (e.g., in miles) between map locations to which these points and display distance 406 on the touchscreen display in response to the establishment of the multi-point contact gesture. Mobile device 400 can continue to display distance 406 on the touchscreen display until mobile device 400 determines that the multi-point contact gesture is no longer being maintained motionlessly against the touchscreen display, at which time mobile device 400 can cease to display distance 406.

FIG. 5 is a block diagram illustrating an example of a mobile device 500 that is capable of presenting information about a path through three or more points of contact in response to the establishment and maintenance of a multi-contact gesture against the device's touchscreen display, according to an embodiment of the invention. In one embodiment, mobile device 500 is a smart phone such as an Apple iPhone. In another embodiment, mobile device 500 is a tablet computer such as an Apple iPad. As shown in FIG. 5, a first point of contact 502, a second point of contact 504, and a third point of contact 508 are being concurrently maintained against the touchscreen display of mobile device 500. Although three points of contact are discussed for purposes of a simplified example, alternative embodiments of the invention can detect and respond to greater quantities of contact points being maintained as part of a multi-point contact gesture. In response to the concurrent maintenance of these points of contact, mobile device 500 can determine a shortest (or other specified criteria-satisfying) path that passes through locations corresponding to each of contact points 502, 504, and 508. Mobile device 500 can plot such a path on the touchscreen display and maintain the display of that path for as long as the multi-point contact gesture is maintained. In one embodiment, mobile device 500 can determine, for each particular contact point of the multiple contact points 502, 504, and 508, which other of the contact points that is not yet connected to the path is closest (or satisfies other specified criteria relative to) that particular contact point. Mobile device 500 can then connect those closest (or other specified criteria-satisfying) contact points together with a path segment. In such an embodiment of the invention, therefore, mobile device 500 can select a path travelling through each of contact points 502, 504, and 508 regardless of the order in which contact points 502, 504, and 508 were established against the touchscreen display of mobile device 500. Mobile device 500 can determine a distance 506 (e.g., in miles) between map locations to which these points and display distance 506 on the touchscreen display in response to the establishment of the multi-point contact gesture. Mobile device 500 can continue to display distance 506 on the touchscreen display until mobile device 500 determines that the multi-point contact gesture is no longer being maintained motionlessly against the touchscreen display, at which time mobile device 500 can cease to display distance 506.

FIG. 6 is a block diagram illustrating an example of a mobile device 600 that is capable of determining an order in which three or more points of contact were established against the device's touchscreen display as part of a multi-contact gesture, and of calculating a path through each of those points based at least in part on that order, according to an embodiment of the invention. In one embodiment, mobile device 600 is a smart phone such as an Apple iPhone. In another embodiment, mobile device 600 is a tablet computer such as an Apple iPad. As shown in FIG. 6, a first point of contact 602, a second point of contact 604, and a third point of contact 608 are being concurrently maintained against the touchscreen display of mobile device 600. Although three points of contact are discussed for purposes of a simplified example, alternative embodiments of the invention can detect and respond to greater quantities of contact points being maintained as part of a multi-point contact gesture. In the illustrated example, contact point 602 was established first in time, then contact point 604 was established second in time, and then contact point 608 was established third in time, though all are concurrently maintained following establishment. In response to the concurrent maintenance of these points of contact, mobile device 600 can determine a time-order-based path that passes through locations corresponding to each of contact points 602, 604, and 608. For example, mobile device 600 can select contact point 602 to be one terminal endpoint of the path due to contact point 602 having been established first in time, and mobile device 600 can select contact point 604 to be the other endpoint of the path due to contact point 604 having been established second in time. Thus, in one embodiment, mobile device 600 can select the first two contact points established in time order to be the endpoints for a path that will travel through all of the contact points. Mobile device 600 can plot such a path on the touchscreen display and maintain the display of that path for as long as the multi-point contact gesture is maintained. In such an embodiment of the invention, therefore, mobile device 600 can select a path travelling through each of contact points 602, 604, and 608 regardless of how close those contact points 602, 604, and 608 are to each other; time-ordering of contact point establishment can trump inter-contact point distance in such an embodiment. Mobile device 600 can determine a distance 606 (e.g., in miles) between map locations to which these points and display distance 606 on the touchscreen display in response to the establishment of the multi-point contact gesture. Mobile device 600 can continue to display distance 606 on the touchscreen display until mobile device 600 determines that the multi-point contact gesture is no longer being maintained motionlessly against the touchscreen display, at which time mobile device 600 can cease to display distance 606. In one embodiment, mobile device 600 can perform reverse geocoding based on all of the latitudinal and longitudinal coordinates corresponding to all of contact points 602, 604, and 608. In such an embodiment, mobile device 600 can send resulting streets addresses for each of contact points 602, 604, and 608 to a remote server. The remote server can then plot an on-road route that goes from the address of one endpoint (e.g., corresponding to contact point 602) to the address of the other endpoint (e.g., corresponding to contact point 604) and that also includes, as “waypoints,” the addresses of the intermediate points (e.g., corresponding to contact point 608). As is explained above, other contact points that are part of a multi-point contact gesture and that are established after the first two contact points have been established can be used to constrain the choice of routes between the endpoints to routes that include those other contact points as waypoints.

In one embodiment of the invention, substantial (e.g., more than a specified minimum threshold amount) movement of any of the multiple contact points can cause mobile device 600 to determine that the multi-point contact gesture has ceased and that some other gesture (e.g., pinch, tilt, pan, etc.) is now being made against the device's touchscreen display. However, in an alternative embodiment of the invention, as long as the two points of contact 602 and 604 established in time-order prior to the other point(s) of contact are maintained in a relatively immobile and stationary manner, mobile device 600 can determine that the multi-point contact gesture is still being maintained even if those other point(s) of contact are substantially moved from the positions against which those other point(s) of contact were initially established. In one such alternative embodiment of the invention, as these other point(s) of contact are moved (e.g., via the sliding of the fingertip along the touchscreen display without breaking contact), mobile device 600 can continuously re-calculate the path that travels through all of contact points 604, 604, and 608 (contact point 608 being the mobile contact point in this example). Mobile device 600 can continuously re-plot or highlight the recalculated paths on the touchscreen display as one or more of the latter-established contact points are slid along the touchscreen display. In one embodiment, mobile device 600 can continuously re-determine routes along fixed channels, such as roads, that most closely follow or approximate a path through each of contact points 602, 604, and 608. Such an embodiment can be useful for allowing a user to visualize alternative road-following (or other channel-following) routes occurring between the first two established contact points 602 and 604. In one embodiment, as mobile device 600 continuously re-determines the paths due to contact point 608 being slid to various different locations against the touchscreen display while contact points 602 and 604 are maintained relatively immobile and stationary, mobile device 600 can also continuously re-calculate the distances 606 of those paths. Mobile device can continue to re-display these re-calculated distances 606 on the touchscreen display until mobile device 600 determines that the multi-point contact gesture is no longer being maintained against the touchscreen display, at which time mobile device 600 can cease to re-display distances 606 in the continuous manner discussed above.

FIG. 7 is a block diagram illustrating an example of a mobile device 700 that is capable of drawing a shape having vertices that include three or more points of contact in response to the establishment and maintenance of a multi-contact gesture against the device's touchscreen display, according to an embodiment of the invention. In one embodiment, mobile device 700 is a smart phone such as an Apple iPhone. In another embodiment, mobile device 700 is a tablet computer such as an Apple iPad. As shown in FIG. 7, a first point of contact 702, a second point of contact 704, and a third point of contact 708 are being concurrently maintained against the touchscreen display of mobile device 700. Although three points of contact are discussed for purposes of a simplified example, alternative embodiments of the invention can detect and respond to greater quantities of contact points being maintained as part of a multi-point contact gesture. In response to the concurrent maintenance of these points of contact, mobile device 700 can determine a shortest circuit that passes through locations corresponding to each of contact points 702, 704, and 708. Mobile device 700 can plot such a circuit on the touchscreen display and maintain the display of that circuit for as long as the multi-point contact gesture is maintained. In one embodiment, mobile device 700 can determine, for each particular contact point of the multiple contact points 702, 704, and 708, which other of the contact points that is not yet connected to the circuit is closest (or satisfies other specified criteria relative to) that particular contact point. Mobile device 700 can then connect those closest contact points together with a circuit segment. After connecting the closest contact points together in this manner, mobile device 700 can then connect together the two contact points that have not yet been connected, thereby completing the circuit. In one embodiment of the invention, the circuit essentially becomes the perimeter of a shape drawn on the touchscreen display of mobile device 700 in response to the performance of the multi-point contact gesture relative to the touchscreen display. Mobile device 700 can determine an area 706 (e.g., in square miles) of the interior of this shape and display area 706 on the touchscreen display in response to the establishment of the multi-point contact gesture. Mobile device 700 can continue to display area 706 on the touchscreen display until mobile device 700 determines that the multi-point contact gesture is no longer being maintained motionlessly against the touchscreen display, at which time mobile device 700 can cease to display distance 706.

In an embodiment discussed above in connection with FIG. 7, the establishment of the multi-point contact against the touchscreen display of mobile device 700 can cause mobile device 700 to draw a shape, such as a polygon, that has locations corresponding to the contact points as the vertices of that shape. However, in alternative embodiments of the invention, the establishment of a multi-point contact against the touchscreen display can cause mobile device 700 to draw alternative shapes based on the points of the multi-point contact gesture. For example, in an alternative embodiment, the establishment of a two-point contact against the touchscreen display can cause mobile device 700 to draw, on the touchscreen display, a circle having a center at the first-established contact point, and a perimeter that passes through the second-established contact point, such that the circle's radius is defined by the distance between the first and second contact points. For another example, in an alternative embodiment, the establishment of a two-point contact against the touchscreen display can cause mobile device 700 to draw, on the touchscreen display, a circle having a perimeter that passes through both of the contact points, such that the circle's diameter is defined by the distance between the first and second contact points, and such that the circle's center lies midway along that diameter. For another example, in an alternative embodiment, the establishment of a three-point contact against the touchscreen display can cause mobile device 700 to draw, on the touchscreen display, an ellipse having a center at the first-established contact point, and a perimeter that passes through both the second-established and third-established contact points, such that one of the ellipse's axes is defined by the distance between the first-established and second-established contact points, and such that the other of the ellipse's axes is defined by the distance between the first-established and third-established contact points. For another example, in an alternative embodiment, the establishment of a two-point contact against the touchscreen display can cause mobile device 700 to draw, on the touchscreen display, a rectangle having a diagonal that runs between both of the contact points, such that the rectangle's upper left vertex is at a location corresponding to one of the contact points, and such that the rectangle's lower right vertex is at a location corresponding to the other of the contact points.

Furthermore, in addition to defining and drawing a shape in response to the establishment of a multi-point contact against its touchscreen display, in one embodiment of the invention, mobile device 700 can automatically select, from among multiple items that are shown on the touchscreen display, all (and only) particular items that are at least partially contained within the area of the shape so defined and drawn. These items can represent a variety of different kinds of entities, depending on the application program in which the selection is being performed. For example, in a drawing application, the items can represent portions of a drawing. For another example, in a spreadsheet application, the items can represent cells. For yet another example, in a word-processing application, the items can represent words. In one embodiment of the invention, in response to a selection of items being made in this manner, mobile device 700 can display information relating to the items for as long as the multi-point contact gesture is being maintained against the touchscreen display. For example, mobile device 700 can at least temporarily display a count of the quantity of the selected items at least partially falling within the selection area.

One embodiment of the invention can take the form of a mobile device that includes a touchscreen display and one or more processors. The touchscreen display can be capable of detecting that a plurality of contacts are concurrently being maintained against a surface of the touchscreen display, and capable of displaying a particular distance in response to the detecting. The one or more one or more processors can be capable of determining a path that includes map locations corresponding to each of the plurality of contacts, and capable of determining a distance of the path as the particular distance.

Embodiments of the present invention can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above can make reference to specific hardware and software components, those skilled in the art will appreciate that different combinations of hardware and/or software components can also be used and that particular operations described as being implemented in hardware might also be implemented in software or vice versa.

Computer programs incorporating various features of the present invention can be encoded and stored on various computer readable storage media; suitable media include magnetic disk or tape, optical storage media such as compact disk (CD) or DVD (digital versatile disk), flash memory, and other non-transitory media. Computer readable media encoded with the program code can be packaged with a compatible electronic device, or the program code can be provided separately from electronic devices (e.g., via Internet download or as a separately packaged computer-readable storage medium).

Thus, although the invention has been described with respect to specific embodiments, it will be appreciated that the invention is intended to cover all modifications and equivalents within the scope of the following claims.

What is claimed is:

1. A method comprising:
detecting, by a computing device, a first point of contact being made against a touchscreen of the device concurrently with a second point of contact being made against the touchscreen;
determining information pertaining to a path between displayed locations corresponding to the first and second concurrent points of contact; and
presenting the information on the touchscreen.

2. The method of claim 1, wherein the information includes a distance of the path.

3. The method of claim 1, wherein the path comprises one or more straight lines between the displayed locations.

4. The method of claim 1, wherein the path comprises one or more roads linking the displayed locations.

5. The method of claim 1, wherein the information includes an amount of time estimated to be required to travel the path.

6. The method of claim 1, wherein the information includes textual directions regarding navigation of the path.

7. The method of claim 1, further comprising:
highlighting the path on a map being displayed on the touchscreen.

8. The method of claim 1, further comprising:
ceasing to present the information on the touchscreen in response to detecting that at least one of the first and second points of contact is either no longer being maintained against the touchscreen or being moved from a position at which said at least one point of contact was originally made against the touchscreen.

9. The method of claim 1, further comprising:
detecting, by a computing device, a third point of contact being made against the touchscreen concurrently with the first and a second points of contact;
wherein determining the information pertaining to the path comprises determining information pertaining to a path that includes displayed locations corresponding to the first, second, and third concurrent points of contact.

10. The method of claim 1, further comprising:
detecting a third point of contact being made against the touchscreen concurrently with the first and a second points of contact; and
determining whether the first point of contact is closer to the second point of contact or the third point of contact; and
displaying, on the touchscreen, in response to determining that the first point of contact is closer to the third point of contact than to the second point of contact, a route that includes (a) a path segment from a location pertaining to the first point of contact to a location pertaining to the third point of contact and (b) a path segment from the location pertaining to the third point of contact to a location pertaining to the second point of contact.

11. The method of claim 1, further comprising:
detecting a third point of contact being made against the touchscreen concurrently with the first and a second points of contact; and
determining an order in which the first, second, and third points of contact were made against the touchscreen; and
calculating a route that (a) begins at a location pertaining to a point of contact that was established prior to each other concurrent point of contact against the touchscreen, (b) ends at a location pertaining to a point of contact that was established after each other concurrent point of contact against the touchscreen, and (c) includes locations pertaining to each point of contact that is concurrently being made against the touchscreen.

12. The method of claim 1, further comprising:
detecting a third point of contact being made against the touchscreen concurrently with the first and a second points of contact; and
determining an order in which the first, second, and third points of contact were made against the touchscreen; and
calculating a route that (a) begins at a location pertaining to a point of contact that was established first in the order, (b) ends at a location pertaining to a point of contact that was established second in the order, and (c) includes locations pertaining to each point of contact that is concurrently being made against the touchscreen.

13. The method of claim 1, wherein the path comprises a shortest route along a plurality of edges of a graph from a node closest to the first point of contact to a node closest to the second point of contact.

14. A computer-readable memory comprising particular instructions that are executable by one or more processors to cause the one or more processors to perform operations, the particular instructions comprising:
instructions to cause a computing device to detect that multiple points of contact are being maintained concurrently against a touchscreen display of the computing device;
instructions to cause the computing device to determine that the multiple points of contact being concurrently maintained are not being moved; and
instructions to cause the computing device to display graphics involving the multiple points of contact in response to detecting that the multiple points of contact are being maintained and are not being moved.

15. The computer-readable memory of claim 14, wherein the particular instructions further comprise:
instructions to cause the computing device to draw one or more lines linking the multiple points of contact.

16. The computer-readable memory of claim 14, wherein the particular instructions further comprise:
instructions to cause the computing device to show, on a map, a shortest route along roads that include all locations corresponding to the multiple points of contact.

17. The computer-readable memory of claim 14, wherein the particular instructions further comprise:
instructions to cause the computing device to create a shape whose perimeter is defined based on the multiple points of contact.

18. The computer-readable memory of claim 14, wherein the particular instructions further comprise:
instructions to cause the computing device to select, from a plurality of items displayed on the touchscreen, all particular items that are at least partially contained within an area whose perimeter is defined based on the multiple points of contact, and only the particular items.

19. The computer-readable memory of claim 14, wherein the particular instructions further comprise:
instructions to cause the computing device to present a distance of a path including locations corresponding to the multiple points of contact for as long as the multiple points of contact are being maintained against the touchscreen;
wherein the distance is specified in a unit of scale of a map that contains the path.

20. A mobile device comprising:
a touchscreen display capable of detecting that a plurality of contacts are concurrently being maintained against a surface of the touchscreen display, and capable of displaying a particular distance in response to the detecting; and
one or more processors capable of determining a path that includes map locations corresponding to each of the plurality of contacts, and capable of determining a distance of the path as the particular distance;
wherein the one or more processors are capable of performing reverse geocoding relative to each of the plurality of contacts in order to map each of the contacts in the plurality of contacts to a separate street address.
